(19) United States
(12) Patent Application Publication
(10) Pub. No.: US 2018/0158177 A1
(43) Pub. Date: Jun. 7, 2018

(54) SYSTEM FOR PROCESSING IMAGES

(71) Applicant: IDEMIA IDENTITY & SECURITY France, Issy Les Moulineaux (FR)

(72) Inventors: Sarah Lannes, Issy Les Moulineaux (FR); Vincent Despiegel, Issy Les Moulineaux (FR); Yann Raphaël Lifchitz, Issy Les Moulineaux (FR); Stephane Gentric, Issy Les Moulineaux (FR)

(21) Appl. No.: 15/831,546

(22) Filed: Dec. 5, 2017

(30) Foreign Application Priority Data
Dec. 7, 2016 (FR) 1662080

(51) Int. Cl. G06T 5/00

(52) U.S. Cl. CPC G06T 5/002; G06T 2207/20182; G06T 2207/20084; G06T 5/003

(57) ABSTRACT

System for processing images including a main neural network, preferably convolution-based (CNN), and at least one preprocessing neural network, preferably convolution-based, upstream of the main neural network, for carrying out before processing by the main neural network at least one parametric transformation f, differentiable with respect to its parameters, this transformation being applied to at least part of the pixels of the image and being of the form p′=f(V(p),Θ) where p is a processed pixel of the original image or of a decomposition of this image, p′ the pixel of the transformed image or of its decomposition, V(p) is a neighborhood of the pixel p, and Θ a vector of parameters, the preprocessing neural network having at least part of its learning which is performed simultaneously with that of the main neural network.

The present invention relates to systems for processing images using neural networks, and more particularly but not exclusively those intended for biometry, in particular the recognition of faces.

It has been proposed to use so-called convolution neural networks (CNN) for the recognition of faces or other objects. The article Deep Learning by Yann Le Cun et al, 436 NATURE VOL 521, 28 May 2015, comprises an introduction to these neural networks.

It is commonplace moreover to seek to carry out a preprocessing of an image in order to correct a defect of the image, such as a lack of contrast for example, by making a correction of the gamma or of the local contrast.

Biometric recognition of faces assumes a great diversity of image acquisition and lighting conditions, giving rise to difficulty in choosing the correction to be made. Moreover, since the improvement in the performance of convolution neural networks is related to fully learnt hidden layers, this gives rise to difficulty in understanding the image processings that it would be useful to apply upstream of such networks.

Consequently, encouraged by the fast development of ever more powerful processors, the current tendency is to increase the power of the convolutional neural networks, and to broaden their learning to variously altered images so as to improve the performance of these networks independently of any preprocessing.

However, although more efficacious, these systems are not completely robust to the presence of artifacts and to the degradation of the image quality. Moreover, increasing the calculational power of computing resources is a relatively expensive solution which is not always suitable.

Existing solutions to the problems of image quality, which thus consist either in enriching the learning bases with examples of problematic images, or in performing the image processing upstream, independently of the problem that it is sought to learn, are therefore not fully satisfactory.

Consequently, there is still a need to further enhance the biometric chains based on convolutional neural networks, in particular so as to render them more robust to various noise and thus improve recognition performance in relation to images of lesser quality.

The article by Peng Xi et al: “Learning face recognition from limited training data using deep neural networks”, 23rd International Conference on Pattern Recognition, 4 Dec. 2016, pages 1442-1447 describes a scheme for recognizing faces using a first neural network to apply an affine transformation to the image, and a second neural network for the recognition of the images thus transformed.

The article by Svoboda Pavel et al: “CNN for license plate motion deblurring”, International Conference on Image Processing, 25 Sep. 2016, pages 3832-3836 describes a method for denoising registration plates using a CNN network.

The article by Chakrabarti Ayan: “A Neural Approach to Blind Motion Deblurring”, ECCV 2016, vol. 9907, pages 221-235 describes the transformation of images into the frequency domain prior to the learning of these data by a neural network so as to estimate convolution parameters for denoising purposes.

The article Spatial Transformer Networks, Max Jaderberg, Karen Simonyan, Andrew Zisserman, Koray Kavukcuoglu, NIPS 2015 describes a processing system designed for character recognition, in which a convolutional preprocessing neural network is used to carry out spatial transformations such as rotations and scalings. The problem issues related to biometry are not tackled in this article. The transformations applied to the pixels are applied to the entire image.

The invention meets the need recalled hereinabove by virtue, according to one of its aspects, of a system for processing images comprising a main neural network, preferably convolution-based (CNN), and at least one preprocessing neural network, preferably convolution-based, upstream of the main neural network, for carrying out before processing by the main neural network at least one parametric transformation, differentiable with respect to its parameters, this transformation being applied to at least part of the pixels of the image, the preprocessing neural network having at least part of its learning which is performed simultaneously with that of the main neural network.

The transformation f according to this first aspect of the invention is of the form

p′=f(V(p),Θ)

where p is the processed pixel of the original image or of a decomposition of this image, p′ the pixel of the transformed image or of its decomposition, V(p) is a neighborhood of the pixel p (in the mathematical sense of the term), and Θ a set of parameters. The neighborhood V(p) does not encompass the whole image.

The preprocessing network thus makes it possible to estimate one or more maps of at least one vector Θ of parameters, with Σ={Θ₁, Θ₂, . . . , Θₙ}, by applying the transformation f.

By “map” is meant a matrix whose resolution may or may not be equal to that of the image.

By decomposition of the image is understood to mean a separation of the image into several components, for example via a Fourrier transformation by separating the phase and the modulus.

The transformation applied to one pixel may be independent of the transformation which is applied to the other pixels of the image. Thus, the transformation performed by the preprocessing network may be applied only to just part of the pixels of the image.

The transformation applied is other than a spatial transformation applied to the entire image as in the article Spatial Transformer Networks hereinabove, and consequently is other than a cropping, a translation, a rotation, a homothety, a projection on a plane or a symmetry.

The transformation applied may be spatially invariant, that is to say that it does not entail any displacement of the pixels on the image.

Training the preprocessing network with the main neural network makes it possible to have a correction which is perfectly suited to the need of the analysis of the descriptors such as are determined by the trained main neural network.

The performance of the image processing system is thereby improved while making it possible, in contradistinction to the known solutions based on enrichment of the learning data, to preserve the capacity of the deep layers of the main network for the learning of the descriptors, while avoiding having to devote it to compensating for image quality problems.

Among other examples, the preprocessing neural network can be configured to act on image compression artifacts and/or on the sharpness of the image.

The neural network can further be configured to apply a colorimetric transformation to the starting images.

More generally, the image preprocessing which is carried out can consist of one or more of the following image processing operators:
pixel-wise (or point-wise) modification operators. This involves for example color, hue or gamma corrections or noise thresholding operations;
local operators, in particular those for managing local blur or contrast, a local operator relying on a neighborhood of the pixel, that is to say more than one pixel but less than the whole image; a local operator makes it possible, on the basis of a neighborhood of an input pixel, to obtain an output pixel;
operators in the frequency space (after image transform), and
more generally, any operation on a multi-image representation deduced from the original image.

By involving one or more operators in the frequency space the way is paved for various possibilities for reducing analog or digital noise, such as reducing the compression artifacts, improving the sharpness of the image, the clarity or the contrast.

These operators also allow various filterings such as histogram equalization, the correction of the dynamic swing of the image, the deletion of patterns (for example of digital watermark or “watermarking” type) or the frequency correction and the cleaning of the image by setting up a system for recovering relevant information in an image.

For example, the preprocessing neural network comprises one or more convolution layers (CONV) and/or one or more fully connected layers (FC).

The processing system can comprise an input operator making it possible to apply an input transformation to starting images so as to generate on the basis of the starting images, upstream of the preprocessing neural network, data in a different space from that of the starting images, the preprocessing neural network being configured to act on these data, the system comprising an output operator designed to restore by an output transformation inverse to the input transformation, the data processed by the preprocessing neural network in the processing space of the starting images and thus to generate corrected images which are processed by the main neural network.

The input operator is for example configured to apply a wavelet transform and the output operator an inverse transform.

In examples of implementation of the invention, the preprocessing neural network is configured to generate a set of vectors corresponding to a low-resolution map, the system comprising an operator configured to generate by interpolation, in particular bilinear interpolation, a set of vectors corresponding to a higher-resolution map, preferably having the same resolution as the starting images.

The main neural network and the preprocessing neural network can be trained to perform a recognition, classification or detection, in particular of faces.

The subject of the invention is further, according to another of its aspects, a method of learning of the main and preprocessing neural networks of a system according to the invention, such as is defined above, in which at least part of the learning of the preprocessing neural network is performed simultaneously with the training of the main neural network.

The learning can in particular be performed with the aid of a base of altered images, noisy images in particular. It is possible to impose a constraint on the direction in which the learning evolves in such a way as to seek to minimize a cost function representative of the correction made by the preprocessing neural network.

The subject of the invention is further, according to another of its aspects, a method for processing images, in which the images are processed by a system according to the invention, such as defined above.

The subject of the invention is further, according to another of its aspects, a method of biometric identification, comprising the step consisting in generating with the main neural network of a system according to the invention, such as defined hereinabove, an item of information relating to the identification of an individual by the system.

The subject of the invention is further, independently or in combination with the foregoing, a system for processing images comprising a main neural network, preferably convolution-based (CNN), and at least one preprocessing neural network, preferably convolution-based, upstream of the main neural network, for carrying out before processing by the main neural network at least one parametric transformation, differentiable with respect to its parameters, this transformation being applied to at least part of the pixels of the image and leaving the pixels spatially invariant, the preprocessing neural network having at least part of its learning which is performed simultaneously with that of the main neural network.

The invention will be able to be better understood on reading the description which follows of nonlimiting examples of implementation of the invention, and on examining the appended drawing in which:

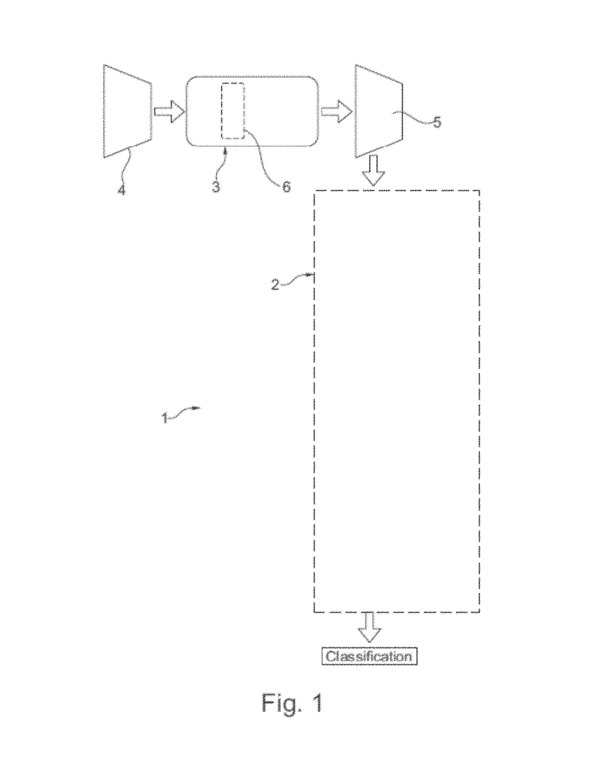

FIG. 1 is a block diagram of an exemplary processing system according to the invention,

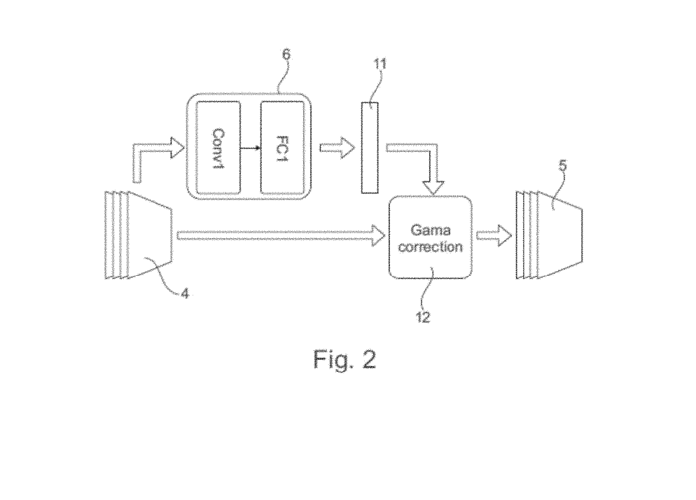

FIG. 2 illustrates an exemplary image preprocessing to carry out a gamma correction,

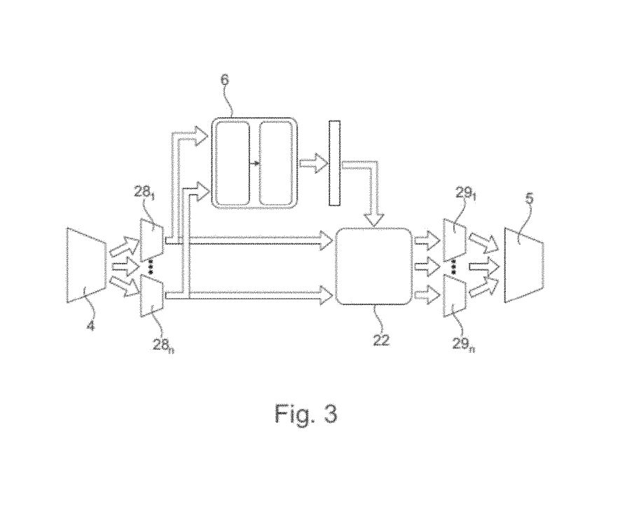

FIG. 3 illustrates a processing applying a change of space upstream of the preprocessing neural network,

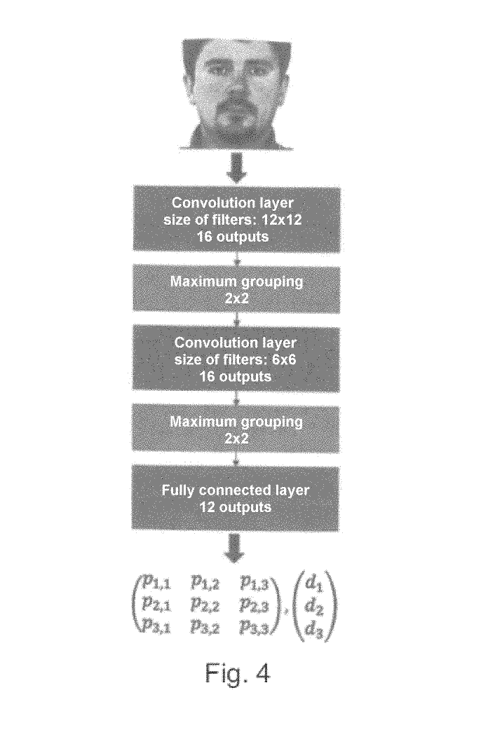

FIG. 4 illustrates an exemplary structure of neural network for colorimetric preprocessing of the image, and

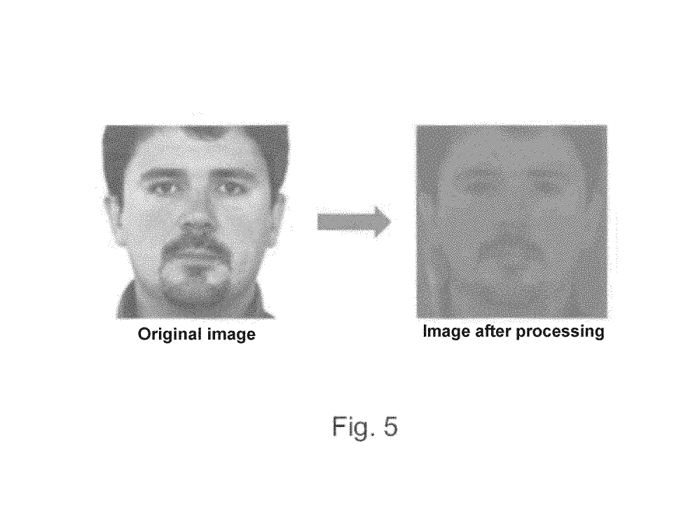

FIG. 5 represents an image before and after colorimetric preprocessing subsequent to the learning of the preprocessing network.

Represented in FIG. 1 is an exemplary system 1 for processing images according to the invention.

In the example considered, this system comprises a biometric convolutional neural network 2 and an image preprocessing module 3 which also comprises a, preferably convolutional, neural network 6 and which learns to apply to the starting image 4 a processing upstream of the biometric network 2.

This processing carried out upstream of the biometric neural network resides in accordance with the invention in at least one parametric transformation which is differentiable with respect to its parameters. In accordance with the invention, the preprocessing neural network 6 is trained with the biometric neural network 2. Thus, the image transformation parameters of the preprocessing network 6 are learnt simultaneously with the biometric network 2. The totality of the learning of the preprocessing neural network 6 can be performed during the learning of the neural network 2. As a variant, the learning of the network 6 is performed initially independently of the network 2 and then the learning is finalized by a simultaneous learning of the networks 2 and 6, thereby making it possible as it were to “synchronize” the networks.

Images whose quality is varied are used for the learning. Preferably, the learning is performed with the aid of a base of altered images, noisy images in particular, and it is possible to impose a constraint on the direction in which the learning evolves in such a way as to seek to minimize a cost function representative of the correction made by the preprocessing neural network.

The transformation or transformations performed by the preprocessing network 6 being differentiable, they do not impede the retro-propagation process necessary for the learning of these networks.

The preprocessing neural network can be configured to carry out a nonlinear transformation, in particular chosen from among: gamma correction of the pixels, local-contrast correction, color correction, correction of the gamma of the image, modification of the local contrast, reduction of noise and/or reduction of compression artifacts.

This transformation can be written in the form:

p′=f(V(p),Θ)

where p is the pixel of the original image or of a decomposition of this image, p′ the pixel of the transformed image or of its decomposition, V(p) is a neighborhood of the pixel p and Θ a set of parameters.

The neural network 2 can be of any type.

An exemplary system for processing images according to the invention, in which the preprocessing module 3 applies a correction of the gamma, that is to say of the curve giving the luminance of the pixels of the output file as a function of that of the pixels of the input file, will now be described with reference to FIG. 2.

In this example, the preprocessing neural network 6 has a single output, namely the gamma correction parameter, which is applied to the entire image.

Here therefore, a single transformation parameter for the image is learnt during the learning of the processing system according to the invention.

The preprocessing neural network 6 comprises for example a convolution-based module Conv 1 and a fully connected module FC1.

The network 6 generates vectors 11 which make it possible to estimate a correction coefficient for the gamma, which is applied to the image at 12 to transform it, as illustrated in FIG. 2.

During the learning, the preprocessing network 6 will learn to make as a function of the starting images 4 a gamma correction for which the biometric network 2 turns out to be efficacious; the correction made is not necessarily that which a human operator would intuitively make to the image in order to improve the quality thereof.

It is possible to successively dispose several preprocessing networks which will learn the image transformation parameters. After each preprocessing network, the image is transformed according to the learnt parameters, and the resulting image can serve as input for the following network, until it is at the input for the main network.

The preprocessing networks can be applied to the components resulting from a transform of the image, such as a Fourier transform or a wavelet transform. It is then the products of these transforms which serve as input for the sub-networks, before the inverse transform is applied to enter the main network.

FIG. 3 illustrates the case of a processing system in which the preprocessing by the network 6 is performed via a multi-image representation deduced from the original image after a transform. This makes it possible to generate sub-images from 28₁ to 28ₙ which are transformed into corrected sub-images 29₁ to 29ₙ, the transformation being for example a wavelet transform.

A map of coefficients of multiplicative factors and thresholds is applied at 22 to the sub-images 28₁ to 28ₙ.

This processing is applicable to any image decomposition for which the reconstruction step is differentiable (for example cosine transform, Fourier transform by separating the phase and the modulus, representation of the input image as the sum of several images, etc. . . . ).

An exemplary processing system suitable for correcting the colors in the starting image, so as to correct the problems of hue and use a more propitious color base for the remainder of the learning, will now be described with reference to FIGS. 4 and 5.

The vector of parameters of the preprocessing network 6 corresponds in this example to a 3×3 switching matrix (P) and the addition of a constant shift (D) for each color channel R, G and B (affine transformation), i.e. 12 parameters.

An exemplary network 6 usable to perform such a processing is represented in FIG. 4. It comprises two convolution layers, two Maxpooling layers and a fully connected layer.

For each pixel

$$( \begin{matrix}r \\ g \\ b\end{matrix} )$$

of the initial image, we have:

$$( \begin{matrix}{r}^{′} & {g}^{′} & {b}^{′}\end{matrix} ) = ( \begin{matrix}r & g & b\end{matrix} ) * ( \begin{matrix}{p}_{1 , 1} & {p}_{1 , 2} & {p}_{1 , 3} \\ {p}_{2 , 1} & {p}_{2 , 2} & {p}_{2 , 3} \\ {p}_{3 , 1} & {p}_{3 , 2} & {p}_{3 , 3}\end{matrix} ) + ( \begin{matrix}{d}_{1} & {d}_{2} & {d}_{3}\end{matrix} )$$

Which gives for all the pixels of the image:

$$( \begin{matrix}{r}_{1}^{′} & {g}_{1}^{′} & {b}_{1}^{′} \\ ⋮ & ⋮ & ⋮ \\ {r}_{n}^{′} & {g}_{n}^{′} & {b}_{n}^{′}\end{matrix} ) = ( \begin{matrix}{r}_{1} & {g}_{1} & {b}_{1} \\ ⋮ & ⋮ & ⋮ \\ {r}_{n} & {g}_{n} & {b}_{n}\end{matrix} ) * ( \begin{matrix}{p}_{1 , 1} & {p}_{1 , 2} & {p}_{1 , 3} \\ {p}_{2 , 1} & {p}_{2 , 2} & {p}_{2 , 3} \\ {p}_{3 , 1} & {p}_{3 , 2} & {p}_{3 , 3}\end{matrix} ) + ( \begin{matrix}{d}_{1} & {d}_{2} & {d}_{3} \\ ⋮ & ⋮ & ⋮ \\ {d}_{1} & {d}_{2} & {d}_{3}\end{matrix} )$$

### EXAMPLE

The color correction processing described with reference to FIGS. 4 and 5 is applied. FIG. 5 gives an exemplary result. It is noted that the result is not the one that would be expected intuitively, since the network 6 has a tendency to exaggerate the saturation of the colors, hence the benefit of combined rather than separate learning of the whole set of networks.

On an internal base of faces not particularly exhibiting any chromatic defect, a relative drop in the false rejects of 3.21% is observed for a false-acceptance rate of 1%.

The invention is not limited to image classification applications and also applies to identification and to authentication in facial biometry.

The processing system according to the invention can further be applied to detection, with biometrics other than that of the face, for example that of the iris, as well as to applications in pedestrian and vehicle recognition, location and synthesis of images, and more generally all applications in detection, classification or automatic analysis of images.

Thus, the invention can be applied to semantic segmentation, to automatic medical diagnosis (in mammography or echography for example), to the analysis of scenes (such as driverless vehicles) or to the semantic analysis of videos for example.

The processing system can further be supplemented with a convolutional preprocessing neural network applying a spatial transformation to the pixels, as described in the article Spatial Transformer mentioned in the introduction.

The invention can be implemented on any type of hardware, for example personal computer, smartphone, dedicated card, supercomputer.

The processing of several images can be carried out in parallel by parallel preprocessing networks.

1. System for processing images comprising a main neural network, preferably convolution-based, and at least one preprocessing neural network, preferably convolution-based, upstream of the main neural network, for carrying out before processing by the main neural network at least one parametric transformation f, differentiable with respect to its parameters, this transformation being applied to at least part of the pixels of the image and being of the form p′=f (V (p), Θ) where p is a processed pixel of the original image or of a decomposition of this image, p′ the pixel of the transformed image or of its decomposition, V(p) is a neighborhood of the pixel p, and Θ a vector of parameters, the preprocessing neural network having at least part of its learning which is performed simultaneously with that of the main neural network.

2. System according to claim 1, the transformation f leaving the pixels spatially invariant on the image.

3. System according to claim 1, the preprocessing network being designed to carry out a modification from pixel to pixel, in particular to perform a color, hue or gamma correction or a noise thresholding operation.

4. System according to claim 1, the preprocessing network being configured to apply a local operator, in particular for managing local blur or contrast.

5. System according to claim 1, the preprocessing network being configured to apply an operator in the frequency space after transform of the image, preferably to reduce analog or digital noise, in particular to perform a reduction of compression artifacts, an improvement in the sharpness of the image, in the clarity or in the contrast, or to carry out a filtering such as histogram equalization, the correction of a dynamic swing of the image, the deletion of patterns of digital watermark type, the frequency correction and/or the cleaning of the image.

6. System according to claim 1, the preprocessing neural network comprising one or more convolution layers and/or one or more fully connected layers.

7. System according to claim 1, the preprocessing neural network being configured to carry out a nonlinear transformation, in particular a gamma correction of the pixels and/or a local-contrast correction.

8. System according to claim 1, the preprocessing neural network being configured to apply a colorimetric transformation.

9. System according to claim 1, comprising an input operator making it possible to apply an input transformation to starting images so as to generate on the basis of the starting images, upstream of the preprocessing neural network, data in a different space from that of the starting images, the preprocessing neural network being configured to act on these data, the system comprising an output operator designed to restore, by an output transformation inverse to the input transformation, the data processed by the preprocessing neural network in the processing space of the starting images and thus to generate corrected images which are processed by the main neural network.

10. System according to claim 9, the input operator being configured to apply a wavelet transform and the output operator an inverse transform.

11. System according to claim 9, the preprocessing neural network being configured to act on image compression artifacts and/or on the sharpness of the image.

12. System according to claim 1, the preprocessing neural network being configured to generate a set of vectors corresponding to a low-resolution map, the system comprising an operator configured to generate by interpolation, in particular bilinear interpolation, a set of vectors corresponding to a higher-resolution map, preferably having the same resolution as the starting images.

13. System according to claim 1, the main neural network and the preprocessing neural network being trained to perform a biometric classification, recognition or detection, in particular of faces.

14. Method of learning of the main and preprocessing neural networks of a system according to claim 1, in which at least part of the learning of the preprocessing neural network is performed simultaneously with the training of the main neural network.

15. Method according to claim 14, in which the learning is performed with the aid of a base of altered images, noisy images in particular, and by imposing a constraint on the direction in which the learning evolves in such a way as to seek to minimize a cost function representative of the correction made by the preprocessing neural network.

16. Method for processing images, in which the images are processed by a system according to claim 1.

17. Method of biometric identification, comprising the step consisting in generating with the main neural network of a system such as defined in claim 1 an item of information relating to the identification of an individual by the system.
